(19) United States
(12) Patent Application Publication
(10) Pub. No.: US 2014/0342208 A1
(43) Pub. Date: Nov. 20, 2014

(54) BATTERY ACCOMMODATION STRUCTURE AND BATTERY ACCOMMODATION METHOD

(71) Applicant: NINTENDO CO., LTD., Kyoto (JP)

(72) Inventors: Toshiaki IWAO, Kyoto (JP); Junji TAKAMOTO, Kyoto (JP); Noboru WAKITANI, Kyoto (JP); Masato IBUKI, Kyoto (JP); Yoshitaka TAMURA, Kyoto (JP)

(73) Assignee: NINTENDO CO., LTD., Kyoto (JP)

(21) Appl. No.: 14/253,425

(22) Filed: Apr. 15, 2014

(30) Foreign Application Priority Data
May 20, 2013 (JP) 2013-106198
May 20, 2013 (JP) 2013-106199

(51) Int. Cl. H01M 2/10

(52) U.S. Cl. CPC H01M 2/1055
USPC 429/100; 29/623.1

(57) ABSTRACT

A battery accommodation structure includes, in an accommodation case configured to accommodating a battery, a positive electrode terminal, a negative electrode terminal, and a clamping spring. The positive electrode terminal is connected to a positive electrode of the battery. The negative electrode terminal is connected to a negative electrode of the battery. The clamping spring is provided between the positive electrode terminal and the negative electrode terminal and clamps a part of an outer peripheral surface of the battery. Thus, it is possible to accommodate the battery without supporting the battery with a cover to be attached after the accommodation of the battery, using a holding member or the like.

### CROSS REFERENCE TO RELATED APPLICATION

The disclosures of Japanese Patent Application No. 2013-106198 and Japanese Patent Application No. 2013-106199, filed on May 20, 2013, are incorporated herein by reference.

### FIELD

The technology shown here relates to a battery accommodation structure and a battery accommodation method, and for example, relates to a structure and a method for, in a device or the like using batteries as a power source, accommodating the batteries.

### BACKGROUND AND SUMMARY

Conventionally, there is a device for accommodating batteries such as dry cell batteries to use the batteries as a power source. The device includes an accommodation portion for accommodating and holding batteries. For example, in this battery accommodation structure, after a battery has been accommodated such that both electrodes of the battery are connected to terminals, a cover is attached to cover the battery.

The battery accommodation structure, however, is a structure where a cover to be attached after the accommodation of a battery and the outer peripheral surface of the battery are caused to abut each other, thereby supporting the accommodated battery. Thus, to stably hold the accommodated battery, it is necessary to provide a predetermined holding member between the cover and the battery, or design a cover that abuts the outer peripheral surface of the battery.

Therefore, it is an object of an exemplary embodiment to provide a battery accommodation structure and a battery accommodation method that can reduce the costs of the provision of a holding member or the like.

To achieve the above object, the exemplary embodiment can employ, for example, the following configurations. It should be noted that it is understood that, to interpret the descriptions of the claims, the scope of the claims should be interpreted only by the descriptions of the claims. If there is a conflict between the descriptions of the claims and the descriptions of the specification, the descriptions of the claims take precedence.

An exemplary configuration of a battery accommodation structure according to an exemplary embodiment accommodates a battery. The battery accommodation structure includes, in an accommodation case configured to accommodate the battery, a positive electrode terminal, a negative electrode terminal, and a clamping spring. The positive electrode terminal is connected to a positive electrode of the battery. The negative electrode terminal is connected to a negative electrode of the battery. The clamping spring is provided between the positive electrode terminal and the negative electrode terminal and clamps a part of an outer peripheral surface of the battery.

Based on the above, the accommodated battery is clamped by the clamping spring provided in the accommodation case. This eliminates the need to support the battery with a cover to be attached after the accommodation of the battery, using a holding member or the like. This can reduce costs to be required for the holding member or the like.

Further, the negative electrode terminal may include a terminal spring. In this case, the clamping spring may be provided in an accommodation space in the accommodation case on the positive electrode terminal side, the accommodation space formed between the positive electrode terminal and the negative electrode terminal.

Further, the clamping spring may be provided at a position where the clamping spring clamps an outer peripheral surface of a part closest to the positive electrode among parts obtained by dividing the battery accommodated in the accommodation case into quarters in a longitudinal direction.

Based on the above, a biasing force is applied to the accommodated battery, whereby it is possible to stably connect to the positive electrode terminal and the negative electrode terminal. Further, the clamping spring is placed at a position away from the terminal spring. This distributes the resisting forces for accommodating and detaching the battery. This facilitates the work of installing the battery and the work of detaching the battery. Further, if the negative electrode terminal includes a terminal spring, the positive electrode side of the assembled battery is more likely to be detached than the negative electrode side. The positive electrode side of the battery, however, is fixed by the clamping spring, whereby it is possible to stably accommodate the battery in the accommodation case.

Further, the negative electrode terminal may include a torsion spring.

Based on the above, the negative electrode terminal includes a torsion spring, whereby it is possible to stably connect to the positive electrode terminal and the negative electrode terminal by applying a biasing force to the accommodated battery. Further, it is possible to attach the battery into the accommodation case by inserting the positive electrode terminal side first, which is provided so as to oppose the negative electrode terminal, and also possible to attach the battery into the accommodation case by inserting the negative electrode terminal side first.

Further, the clamping spring may include a supporting spring. The supporting spring, in an inner surface thereof clamping the battery by abutting an outer peripheral surface of the battery on both sides, protrudes further inward than the inner surface from a lower portion of the inner surface to support the outer peripheral surface of the battery in an upward direction from the lower portion.

Based on the above, even if a battery having an outer diameter smaller than the inner dimension of the clamping spring is attached, the supporting spring supports the battery. This makes it possible to stably accommodate the battery.

Further, a cover configured to detachably cover the accommodated battery may be further included. If the cover has been attached, an inner surface of the cover may abut at least a part of an outer surface of the clamping spring.

Based on the above, the accommodated battery is firmly clamped by the clamping spring. This makes it possible to accommodate the battery more stably.

An exemplary configuration of a battery accommodation method according to the exemplary embodiment accommodates a battery. The battery accommodation method electrically connects electrodes of a battery to be accommodated to a positive electrode terminal and a negative electrode terminal by fitting the electrodes between the positive electrode terminal and the negative electrode terminal, and accommodates the battery in the accommodation case by clamping a part of the outer peripheral surface of the battery with a clamping spring.

Based on the above, the accommodated battery is clamped by the clamping spring provided in the accommodation case. This eliminates the need to support the battery with a cover to be attached after the accommodation of the battery, using a holding member or the like. This can reduce costs to be required for the holding member or the like.

According to the exemplary embodiment, the accommodated battery is clamped by the clamping spring provided in the accommodation case. This eliminates the need to support the battery with a cover to be attached after the accommodation of the battery, using a holding member or the like. This can reduce costs to be required for the holding member or the like.

These and other objects, features, aspects and advantages of the exemplary embodiments will become more apparent from the following detailed description of the exemplary embodiments when taken in conjunction with the accompanying drawings.

### BRIEF DESCRIPTION OF THE DRAWINGS

FIG. 1 is an external perspective view of a non-limiting example of a device 1 having a battery accommodation structure;

FIG. 2 is an external perspective view of a non-limiting example of the inside of the device 1 from which a rear end housing 3 has been detached;

FIG. 3 is an external perspective view of a non-limiting example of the state where batteries have been attached to the device 1;

FIG. 4 is an external perspective view of a non-limiting example of the state where a slider 20 has been detached from the device 1;

FIG. 5 is a diagram illustrating a non-limiting example of the procedure of installing batteries into the device 1;

FIG. 6 is a vertical cross-sectional view of a non-limiting example of the internal structure of the device 1;

FIG. 7A is an external view of a non-limiting example of the inside of the device 1 as viewed from above when the rear end housing 3 has been detached from the device 1;

FIG. 7B is a cross-sectional view along a non-limiting example of a cross section AA in the device 1 in FIG. 7A;

FIG. 7C is a cross-sectional view along a non-limiting example of a cross section BB in the device 1 in FIG. 7A;

FIG. 7D is a cross-sectional perspective view of a non-limiting example of the state where the device 1 in FIG. 7A has been cut along the cross section BB and a part of the slider 20 has been further cut;

FIG. 8A is an external top view of a non-limiting example of the slider 20 in which a notched spring 29 is provided;

FIG. 8B is an external perspective view of a non-limiting example of the slider 20 in which the notched spring 29 is provided; and

FIG. 9 is a diagram showing a non-limiting example of the state of a partition portion that can be displaced to be buried in a wall surface of an accommodation case and to stand in a battery accommodation space from the wall surface.

### DETAILED DESCRIPTION OF NON-LIMITING EXAMPLE EMBODIMENTS

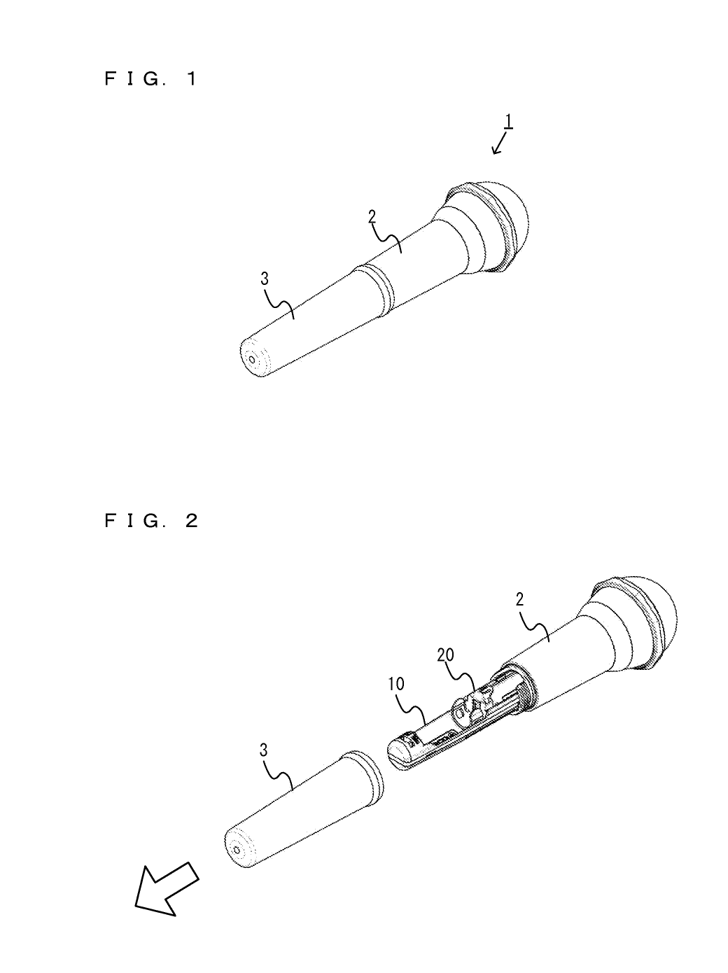

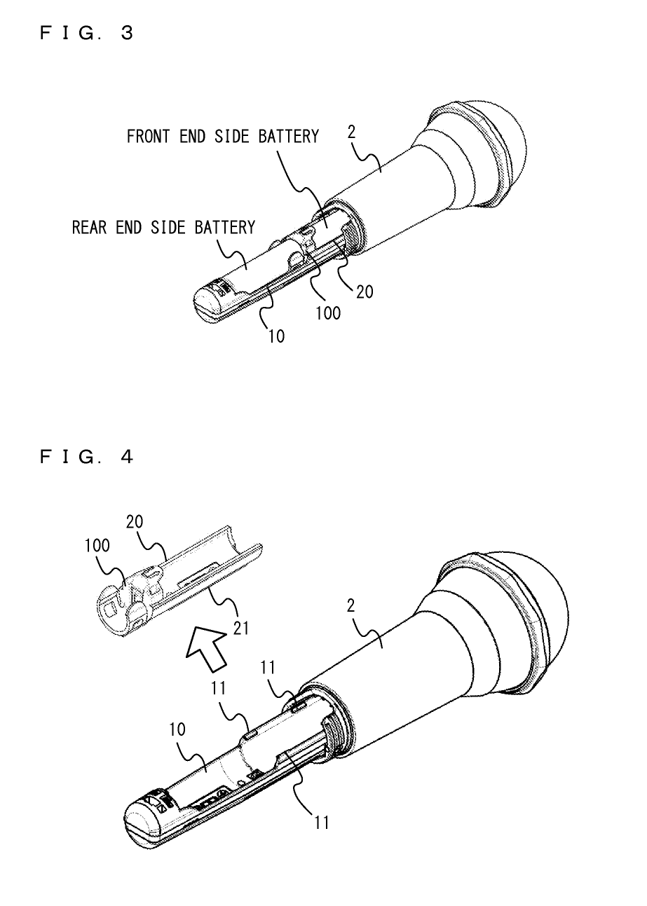

With reference to FIGS. 1 to 4, a battery accommodation structure according to an exemplary embodiment is described. It should be noted that FIG. 1 is an external perspective view of an example of a device 1 having the battery accommodation structure. FIG. 2 is an external perspective view of an example of the inside of the device 1 from which a rear end housing 3 has been detached. FIG. 3 is an external perspective view of an example of the state where batteries have been attached to the device 1. FIG. 4 is an external perspective view of an example of the state where a slider 20 has been detached from the device 1. For example, the device 1 is an electrical device, an electronic device, or the like that uses batteries as a power source. It should be noted that in the exemplary embodiment, the device 1 is described using a wireless microphone as an example.

In FIGS. 1 and 2, the device 1 includes a main body 2 and a rear end housing 3. The rear end housing 3 is formed into a generally cylindrical shape, one end of which is closed. The rear end housing 3 is configured to be attachable to and detachable from the main body 2.

The main body 2 includes a battery accommodation portion having a battery accommodation structure for accommodating batteries that serve as a power source for the device 1. The battery accommodation portion generally includes an accommodation case 10 and a slider 20. For example, the accommodation case 10 and the slider 20 are formed of an ABS (acrylonitrile-butadiene-styrene) resin. It should be noted that the accommodation case 10 and the slider 20 may be formed of another thermoplastic resin, or may be formed of another resin such as a thermosetting resin. If the rear end housing 3 has been detached from the main body 2, the upper surface of a part of the battery accommodation portion is open to the outside (the state of FIG. 2). Further, if the rear end housing 3 has been attached to the main body 2, the part of the battery accommodation portion that is openable to the outside is accommodated within a hollow space of the rear end housing 3 (the state of FIG. 1).

As shown in FIGS. 2 to 4, the accommodation case 10 is formed of a semicylindrical member capable of accommodating within itself batteries of predetermined shapes, and is fixedly provided in the main body 2. Specifically, the device 1 is configured to allow two batteries to be attached thereto as a power source, and the accommodation case 10 accommodates two batteries.

The slider 20 is formed of a semicylindrical member capable of accommodating within itself batteries of predetermined shapes, and is configured to be slidable along the cylindrical inner surface of the accommodation case 10 in the long axis direction (hereinafter referred to as a “front-back direction”) of the device 1. Specifically, the slider 20 accommodates, between the two batteries, the battery (a front end side battery) on the front end side of the device 1, and the size of the slider 20 is such that entire semicylindrical inner surface of the slider 20 is in contact with the outer surface of the front end side battery. Further, the slider 20 is so formed that the cylindrical outer surface of the slider 20 is slidable along the cylindrical inner surface of the semicylindrical shape member of the accommodation case 10 in the front-back direction while fitting the cylindrical inner surface.

As shown in FIG. 4, on the rear end side of the slider 20, a division wall 100 is formed, which supports the rear end of a front end side battery with the front end side battery installed. As is clear from FIG. 3, if a front end side battery and a rear end side battery have been installed into the battery accommodation portion, the division wall 100 is sandwiched between the front end side battery and the rear end side battery and has the function of partitioning an electrode (for example, a negative electrode) of the front end side battery and an electrode (for example, a positive electrode) of the rear end side battery, and electrically connecting these electrodes together via predetermined terminals (a front end side negative electrode terminal 23 and a rear end side positive electrode terminal plate 24 described later).

Further, as shown in FIG. 4, on the cylindrical inner surface of the accommodation case 10, a plurality of claw portions 11, which are so shaped as to protrude toward the center of the cylinder, are formed at positions arranged in the front-back direction. Then, the slider 20 is attached to the accommodation case 10 such that the semicylindrical outer surface of the slider 20 is in contact with the semicylindrical inner surface of the accommodation case 10 below the positions of the plurality of claw portions 11. It should be noted that each of the plurality of claw portions 11 protrudes toward the center of the cylinder from the cylindrical inner surface of the accommodation case 10, and therefore, when the slider 20 slides in the front-back direction, functions as a guide that prevents the slider 20 from coming off upward, to which the accommodation case 10 is open.

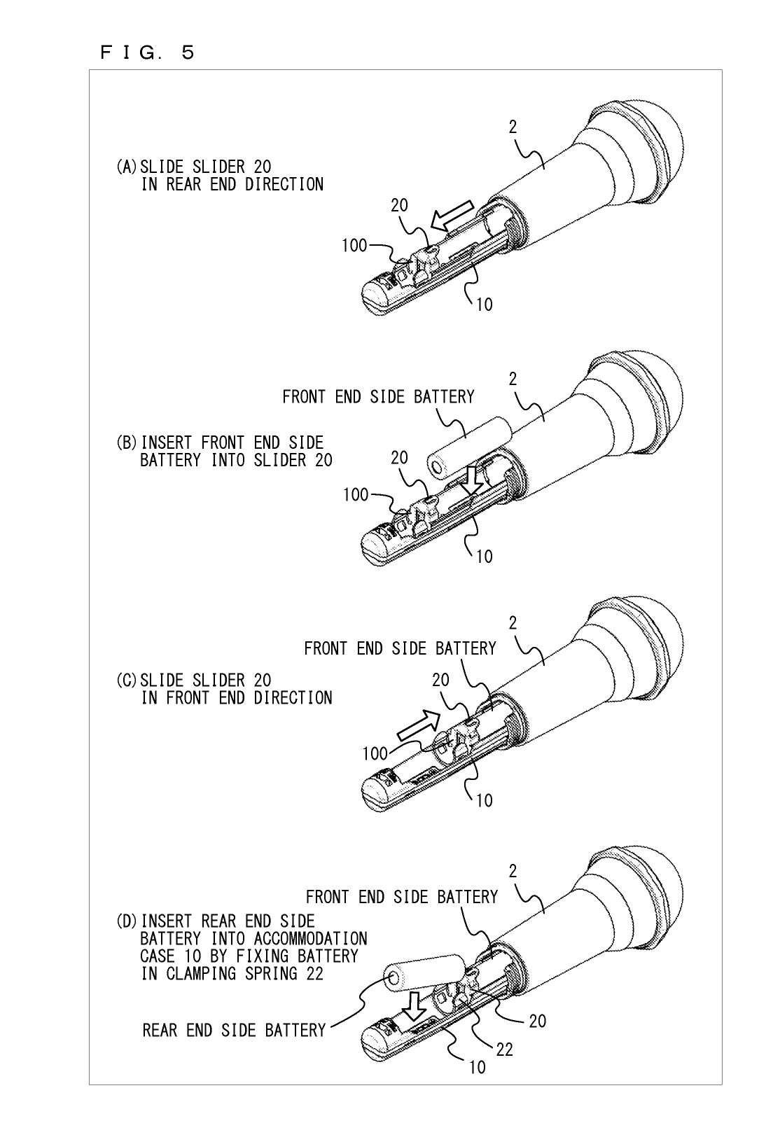

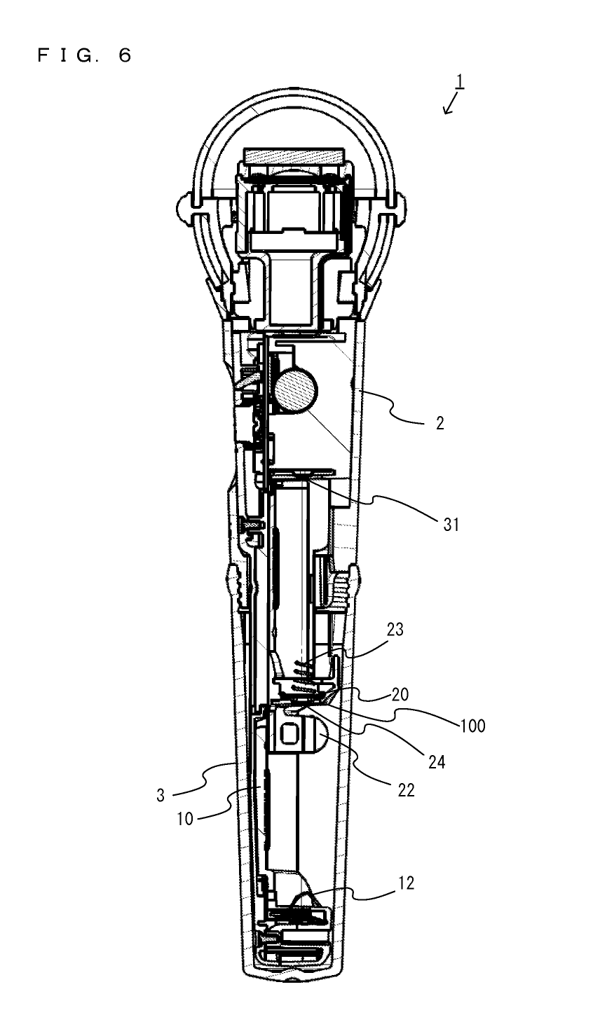

Next, with reference to FIG. 5, the procedure of installing batteries into the device 1 is described. It should be noted that FIG. 5 is a diagram illustrating an example of the procedure of installing batteries into the device 1.

In FIG. 5, when batteries (for example, size AA batteries) are installed into the device 1, the rear end housing 3 is detached from the main body 2 as shown in FIG. 2, so that a part of an upper portion of the battery accommodation portion is open. Then, the slider 20 is slid along the inner surface of the accommodation case 10 in the rear end direction (backward), so that the semicylindrical inner surface for accommodating a front end side battery in the slider 20 is exposed to the outside through the opening of the battery accommodation portion (the state of (A) of FIG. 5).

Next, a front end side battery is inserted and installed into the slider 20 through the opening (see (B) of FIG. 5). At this time, the size of the slider 20 is such that the semicylindrical inner surface of the slider 20 is in contact with the outer surface of the front end side battery, and therefore, the inserted front end side battery is placed in contact with the approximate entirety of the semicylindrical inner surface of the slider 20, or in contact with the semicylindrical inner surface of the slider 20 with a predetermined clearance therebetween. Thus, with the slider 20 slid to the rear end side of the accommodation case 10, it is possible to freely put and take the front end side battery in and out of the slider 20. Further, as an example, the front end side battery is installed into the slider 20 such that the negative electrode of the front end side battery is placed on the rear end side. This enables the negative electrode of the front end side battery to come into contact with a terminal (the front end side negative electrode terminal 23 described later) provided in the division wall 100 and having a coiled terminal spring.

Next, with the front end side battery installed, the slider 20 is slid along the inner surface of the accommodation case 10 in the front end direction (forward) (see (C) of FIG. 5). Thus, parts of the slider 20 and the front end side battery are inserted together into the main body 2. It should be noted that as will be apparent later, the slider 20 is slidable in the forward direction to a position where an electrode (for example, a positive electrode) of the installed front end side battery comes into contact with a front end side positive electrode terminal plate 31 provided in the main body 2. Then, a front portion of the slider 20 abuts the main body 2 with the positive electrode of the front end side battery in contact with the front end side positive electrode terminal plate 31, whereby the slider 20 is slidable to the innermost position in the forward direction. Then, if the slider 20 has been moved to the innermost position, a front end portion (for example, an approximate half in the forward direction) of the slider 20 and a positive electrode side portion (for example, an approximate half on the positive electrode side) of the front end side battery are inserted together into the main body 2. Then, if the slider 20 has been slid to the innermost position with the front end side battery installed, a space for inserting a rear end side battery is formed between the division wall 100 of the slider 20 and the rear end of the accommodation case 10.

Next, a rear end side battery is inserted and installed into the accommodation case 10 through the opening (see (D) of FIG. 5). Here, on the rear end side of the division wall 100 of the slider 20, a clamping spring 22 is provided, so that the rear end side battery is inserted by clamping it with the clamping spring 22 to fit it. Further, at the rear end of the accommodation case 10, a rear end side negative electrode terminal 12 having a torsion spring is provided, so that the negative electrode of the rear end side battery and the rear end side negative electrode terminal 12 are brought into contact with each other, and the torsion spring is caused to contract, thereby inserting the rear end side battery. Further, the slider 20 is placed such that the division wall 100 is pressed to the rear end side by the biasing force of a coiled terminal spring included in the front end side negative electrode terminal 23. Thus, the positive electrode of the rear end side battery and the rear end side positive electrode terminal plate 24 provided in the division wall 100 are brought into contact with each other, and the terminal spring is caused to contract, thereby inserting the rear end side battery. Thus, if installed into the accommodation case 10, the rear end side battery is clamped by the clamping spring 22 in the up, down, left, and right directions and is fixed at a position in the front-back direction where the biasing force of the torsion spring included in the rear end side negative electrode terminal 12 and the biasing force of the terminal spring included in the front end side negative electrode terminal 23 are balanced. It should be noted that a description will be given later of a detailed mechanism in which the batteries installed into the battery accommodation portion of the device 1 are fixed in the battery accommodation portion.

It should be noted that the rear end side battery is installed into the accommodation case 10 such that the negative electrode of the rear end side battery is placed on the rear end side, in which case, the front end side of the rear end side battery is clamped by the clamping spring 22, and the rear end side of the rear end side battery is supported by the torsion spring. Here, the torsion spring is a spring member used by being subjected to the moment of force (the torque) about the coil axis. The battery to be installed may be moved downward from above, whereby the torsion spring can be caused to contract in the backward direction and twisted. Alternatively, the battery to be installed may be moved from the forward direction to the backward direction, whereby the torsion spring can be caused to contract in the backward direction and twisted. Thus, the rear end side battery can be inserted such that its positive electrode side is inserted first, or its negative electrode side is inserted first. For example, as shown in (D) of FIG. 5, while the positive electrode of the rear end side battery and the rear end side positive electrode terminal plate 24 are brought into contact with each other, the positive electrode side of the rear end side battery may be clamped by the clamping spring 22, thereby inserting the positive electrode side of the rear end side battery into the accommodation case 10. Then, while the negative electrode side of the rear end side battery and the torsion spring are brought into contact with each other, the negative electrode side of the rear end side battery and the torsion spring may be pushed downward, whereby the torsion spring may be caused to contract in the backward direction and twisted. Then, the negative electrode side of the rear end side battery may be inserted and installed into the accommodation case 10. Alternatively, with the negative electrode of the rear end side battery and the torsion spring in contact with each other, the negative electrode of the rear end side battery and the torsion spring may be moved from the forward direction to the backward direction, whereby the torsion spring may be caused to contract in the backward direction and twisted. Then, the negative electrode side of the rear end side battery may be inserted into the accommodation case 10. Then, the positive electrode side of the rear end side battery may be clamped by the clamping spring 22, and the positive electrode side of the rear end side battery may be inserted and installed into the accommodation case 10.

Next, with reference to FIG. 6, a description is give of the structure where the batteries installed into the battery accommodation portion of the device 1 are fixed so as to be arranged in the front-back direction. It should be noted that FIG. 6 is a vertical cross-sectional view of an example of the internal structure of the device 1.

In FIG. 6, the front end side positive electrode terminal plate 31 is provided inside the main body 2 at a position where the front end side positive electrode terminal plate 31 abuts the positive electrode of the front end side battery installed into the slider 20. For example, the front end side positive electrode terminal plate 31 is formed of a metal plate material having a protruding portion for abutting the positive electrode of the front end side battery, and is fixedly provided inside the main body 2. Further, in the division wall 100 of the slider 20, the front end side negative electrode terminal 23 and the rear end side positive electrode terminal plate 24 are provided. The rear end side of the front end side negative electrode terminal 23 and the front end side of the rear end side positive electrode terminal plate 24 are joined so as to be electrically connected together, and are fixedly provided in the division wall 100 in the joined state. For example, the front end side negative electrode terminal 23 includes a coiled terminal spring expandable and contractible in the front-back direction, and is provided, in the state of being fixed in the division wall 100, at a position where the front end side of the terminal spring and the negative electrode of the front end side battery come into contact with each other. The rear end side positive electrode terminal plate 24 is formed of a metal plate material having a protruding portion for abutting the positive electrode of the rear end side battery, and is provided, in the state of being fixed in the division wall 100, at a position where the rear end side protruding surface and the positive electrode of the front end side battery come into contact with each other. Further, at the rear end of the accommodation case 10, the rear end side negative electrode terminal 12 is provided at a position where the rear end side negative electrode terminal 12 comes into contact with the negative electrode of the rear end side battery installed into the accommodation case 10. For example, the rear end side negative electrode terminal 12 includes a torsion spring (a torsion coil spring) having a biasing force in the forward direction, and is provided, in the state of being fixed in a rear end portion of the accommodation case 10, at a position where the front end side of the torsion spring and the negative electrode of the rear end side battery come into contact with each other. It should be noted that the front end side positive electrode terminal plate 31 and the rear end side negative electrode terminal 12 may be formed of commonly used brass. However, the terminals (the front end side negative electrode terminal 23 and the rear end side positive electrode terminal plate 24) placed between the front end side battery and the rear end side battery may be formed of stainless steel or the like, which has a relatively high strength, in order to improve the durability against the stress generated by swinging the device 1. Alternatively, the torsion spring may be formed of two components, namely a spring member and plate metal, such that the spring member is formed of stainless steel, and the plate metal is formed of brass.

The front end side battery installed into the battery accommodation portion of the device 1 is placed such that the positive electrode of the front end side battery is in contact with the protruding surface of the front end side positive electrode terminal plate 31, and the negative electrode of the front end side battery is in contact with the front end side negative electrode terminal 23. Further, the rear end side battery installed into the battery accommodation portion of the device 1 is placed such that the positive electrode of the rear end side battery is in contact with the protruding surface of the rear end side positive electrode terminal plate 24, and the negative electrode of the rear end side battery is in contact with the rear end side negative electrode terminal 12. Here, the terminal spring included in the front end side negative electrode terminal 23 abuts the negative electrode of the front end side battery in a contracting state, and the torsion spring included in the rear end side negative electrode terminal 12 abuts the negative electrode of the rear end side battery such that the torsion spring is twisted in the backward direction and has a biasing force in the forward direction. Thus, the front end side battery and the rear end side battery are placed so as to be biased by the biasing force of the terminal spring included in the front end side negative electrode terminal 23 and the biasing force of the torsion spring included in the rear end side negative electrode terminal 12, and are placed at positions where the biasing forces are balanced. That is, a plurality of batteries are supported by a plurality of spring members, and therefore, it is possible to equalize the biasing forces acting on the batteries. Further, the front end side battery and the rear end side battery are connected together via the front end side negative electrode terminal 23 and the rear end side positive electrode terminal plate 24, and therefore, the batteries are not directly connected together. This can prevent the reduction in the durability or the like due to the fact that the batteries interfere with each other by an external shock, for example.

Further, the negative electrode of the front end side battery is connected to the coiled terminal spring, and therefore, the procedure of installing the front end side battery is such that its negative electrode side is inserted first, and then, its positive electrode side is fit in. On the other hand, the negative electrode of the rear end side battery is connected to the negative electrode terminal including the torsion spring, and therefore, the procedure of installing the rear end side battery may be such that its negative electrode side is inserted first, and then, its positive electrode side is fit in, or may be such that its positive electrode side is inserted first, and then, its negative electrode side is fit in.

Here, the torsion spring used as the rear end side negative electrode terminal 12 is configured such that the biasing force per unit length in the backward direction caused by the rear end side battery pressing the torsion spring is larger than the biasing force per unit length caused by the expansion and contraction of the terminal spring used as the front end side negative electrode terminal 23. This makes it possible to certainly slide the slider 20 to the innermost position and certainly fix the slider 20 at the innermost position, which enables the fixing of the division wall 100 always at the same position (that is, each of the front end side battery and the rear end side battery always at the same position) when the batteries have been installed.

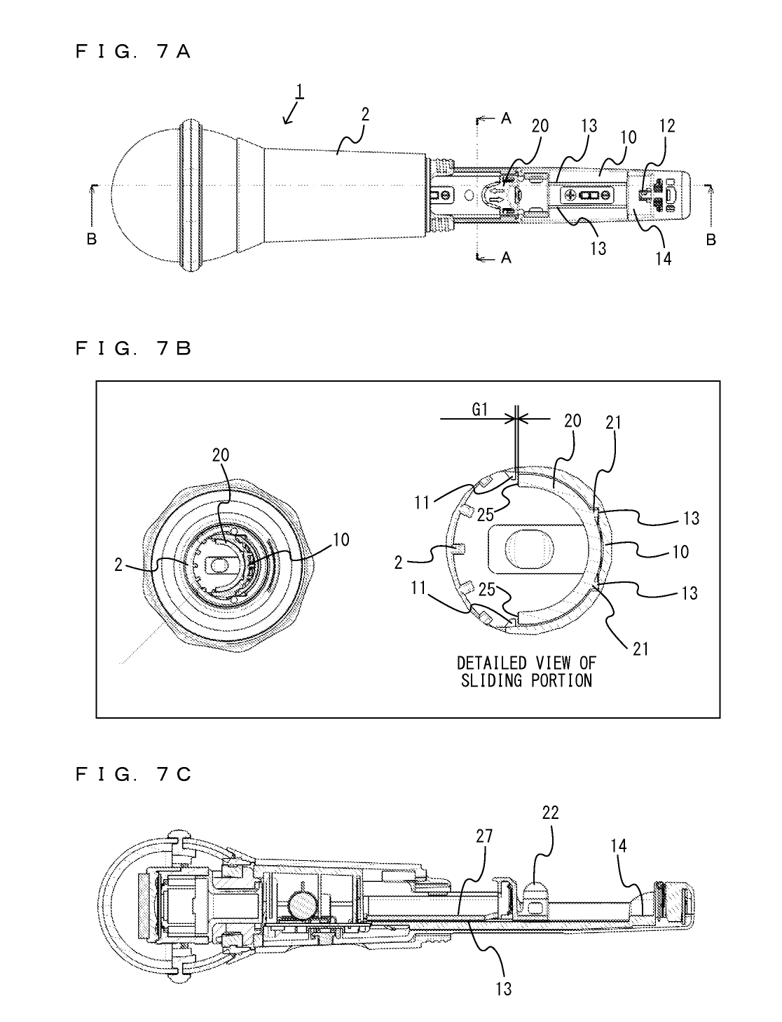

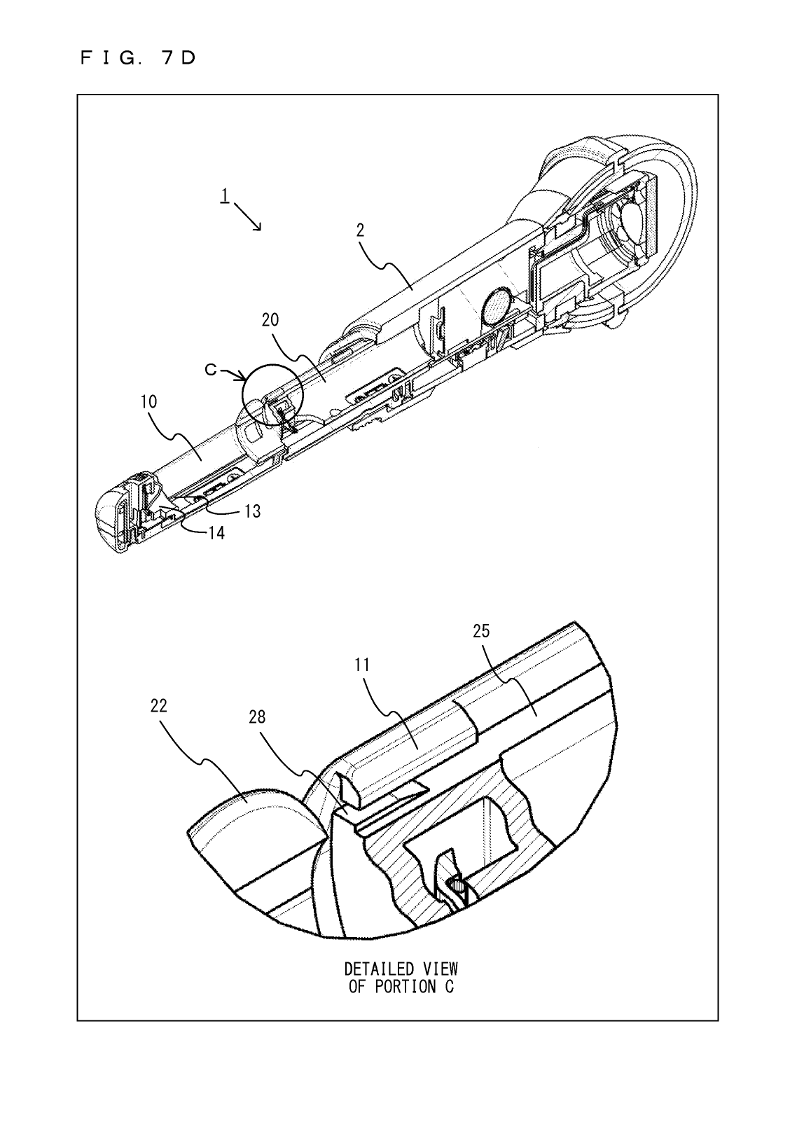

Next, with reference to FIGS. 7A to 7D, a description is given of the structure where the slider 20 slides along the accommodation case 10 and the structure where the batteries installed into the battery accommodation portion are fixed in the up, down, left, and right directions. It should be noted that FIG. 7A is an external view of an example of the inside of the device 1 as viewed from above when the rear end housing 3 of the device 1 has been detached from the device 1. FIG. 7B is a cross-sectional view along an example of a cross section AA in the device 1 in FIG. 7A. FIG. 7C is a cross-sectional view along an example of a cross section BB in the device 1 in FIG. 7A. FIG. 7D is a cross-sectional perspective view of an example of the state where the device 1 in FIG. 7A has been cut along the cross section BB and a part of the slider 20 has been further cut.

In FIGS. 7A to 7D, in a bottom portion of the semicylindrical outer surface of the slider 20, two protruding lines 21 extend in the front-back direction. Further, in a bottom portion of the semicylindrical inner surface of the accommodation case 10, two line grooves 13 are formed in the front-back direction so that the protruding lines 21 can slide in the two line grooves 13. Then, with the slider 20 attached in the accommodation case 10, the protruding lines 21 are engaged with the line grooves 13. The protruding lines 21 slide in the state of being engaged with the line grooves 13, whereby the slider 20 slides in the front-back direction in the accommodation case 10.

Further, as shown in a detailed view of a sliding portion in FIG. 7B, in the state where the slider 20 is sliding in the front-back direction in the accommodation case 10 with the protruding lines 21 and the line grooves 13 engaged with each other, a gap G1 is formed between the claw portions 11, which are arranged next to each other in the front-back direction, and upper surface end portions 25 of the slider 20. Thus, when the slider 20 is slid in the accommodation case 10, the slider 20 is not pressed downward by the claw portions 11. This makes it possible to move the slider 20 in a sliding manner in the front-back direction without generating a great resisting force.

Meanwhile, as shown in a detailed view of a portion C in FIG. 7D, if the slider 20 has been placed in the innermost position, a stepped portion 28 is formed in a part of the upper surface end portion 25 of the slider 20 that is located below the claw portion 11 formed furthest in the backward direction. It should be noted that FIG. 7D shows only the stepped portion 28 provided on the left in the forward direction for ease of description. A similar stepped portion 28, however, is also formed on the right in the forward direction in a part of the upper surface end portion 25 of the slider 20. Each stepped portion 28 is formed to be higher than the other parts of the upper surface end portion 25 of the slider 20 such that the upward protrusion of the stepped portion 28 has a dimension equal to or greater than the gap G1. Thus, if the slider 20 has slid to the innermost position, the left and right claw portions 11 formed furthest in the backward direction abut the stepped portions 28, and the slider 20 is pressed against the bottom portion (for example, the line grooves 13) of the accommodation case 10. Consequently, if the slider 20 has slid to the innermost position with the front end side battery assembled, the slider 20 is fixed by the claw portions 11 in the up-down direction in the accommodation case 10.

If the front end side battery assembled in the slider 20 has been slid to the innermost position, a lower part of the outer peripheral surface of the front end side battery is in contact with a semicylindrical inner surface bottom portion 27 of the slider 20 with the positive electrode and the negative electrode of the front end side battery in contact with the front end side positive electrode terminal plate 31 and the front end side negative electrode terminal 23, respectively. Then, an upper part of the outer peripheral surface of the front end side battery assembled in the slider 20 is pressed downward while abutting a part of the inner wall surface of the main body 2. Thus, if the front end side battery assembled in the slider 20 has been slid to the innermost position, the outer peripheral surface of the front end side battery is sandwiched between the inner wall surface of the main body 2 and the semicylindrical inner surface bottom portion 27 of the slider 20. Thus, the front end side battery is fixed in the up, down, left, and right directions in the device 1.

In the rear end side battery assembled in the accommodation case 10, the outer peripheral surface of the rear end side battery is clamped by the clamping spring 22 on the forward side with the positive electrode and the negative electrode of the rear end side battery in contact with the rear end side positive electrode terminal plate 24 and the rear end side negative electrode terminal 12, respectively. Here, the clamping spring 22 clamps the rear end side battery in the up, down, left, and right directions, and therefore can fix the rear end side battery by pressing it against the bottom surface of the accommodation case 10. Further, in a rear end bottom portion of the accommodation case 10, a rear end side battery mounting surface 14 is formed. The rear end side battery mounting surface 14 is formed into an arcuate surface of the same shape as a part of the inner surface of the clamping spring 22 and also formed as high as the inner surface of the clamping spring 22, and is formed upward to be higher than the bottom portion of the accommodation case 10, in which the line grooves 13 are formed. Thus, a front portion of a lower part of the outer peripheral surface of the rear end side battery abuts the inner surface of the clamping spring 22, and a rear portion of the lower part abuts the rear end side battery mounting surface 14. Thus, the rear end side battery is assembled in a stable orientation in the accommodation case 10. As described above, the clamping spring 22 fixes the rear end side battery in the direction of pressing it against the bottom surface of the accommodation case 10. This makes it possible to stably fix the rear end side battery while abutting the inner surface of the clamping spring 22 and the rear end side battery mounting surface 14 by the clamping force of the clamping spring 22. The rear end side battery is thus clamped by the clamping spring 22. This eliminates the need for a mechanism for fixing the rear end side battery by further causing the rear end side battery to abut another member. For example, if the rear end housing 3 according to the exemplary embodiment is generally conical, it is very difficult to achieve a mechanism for fixing the rear end side battery by causing the rear end housing 3 and the rear end side battery to abut each other. Even without such a mechanism, however, it is possible to stably support the rear end side battery with the clamping spring 22. Further, in the case of a general battery case, there is a need for a mechanism for fixing a battery to be accommodated by causing the battery case to abut the battery to be accommodated while causing a cover of the battery case to abut the battery to be accommodated with a predetermined holding member therebetween. The battery to be accommodated, however, may be clamped by the clamping spring 22. This eliminates the need for a battery holding mechanism using such a holding member. This makes it possible to stably hold the accommodated battery while reducing costs.

It should be noted that although not shown in the figures, if the rear end housing 3 has been attached to the main body 2, the inner wall surface of the rear end housing 3 and the outer peripheral surface of the clamping spring 22 may abut each other, thereby applying to the clamping spring 22 a force in the direction of causing the clamping spring 22 to contract in the axial direction of the rear end housing 3. Consequently, if the rear end housing 3 has been attached to the main body 2, the force of the clamping spring 22 clamping the rear end side battery further increases, and the rear end side battery is assembled more stably in the accommodation case 10.

Further, the clamping spring 22 may be provided at a position where the clamping spring 22 can clamp the outer peripheral surface of the rear end side battery to be accommodated near the positive electrode of the rear end side battery (for example, the part closest to the positive electrode among the parts obtained by dividing the rear end side battery into quarters in the longitudinal direction). In this case, the clamping spring 22 and the rear end side battery mounting surface 14 can support a lower portion of the outer peripheral surface of the rear end side battery on the positive electrode side and a lower portion of the outer peripheral surface on the negative electrode side, respectively. The support for the lower portions of the rear end side battery on both sides makes it possible to stably accommodate the rear end side battery. Further, even if the rear end side negative electrode terminal 12 includes a coiled terminal spring, it is possible to easily fit the positive electrode side of the rear end side battery into the clamping spring 22 after installing the negative electrode side of the rear end side battery into the accommodation case 10. Further, if the rear end side negative electrode terminal 12 includes a terminal spring, the positive electrode side of the assembled rear end side battery is more likely to come off upward than the negative electrode side. The clamping spring 22, however, fixes the positive electrode side of the rear end side battery in the accommodation case 10, whereby it is possible to stably accommodate the rear end side battery in the accommodation case 10. Further, the resisting force caused when the positive electrode side of the rear end side battery is fit into the clamping spring 22, the resisting force for causing the torsion spring of the rear end side negative electrode terminal 12 to contract by the negative electrode side of the rear end side battery, and the resisting force caused when the rear end side battery is detached may be distributed, whereby it is also possible to reduce the resisting force caused when the rear end side battery is installed.

As described above, in the battery accommodation structure described above, in the accommodation case 10, a partition portion for partitioning a first accommodation space for accommodating the front end side battery and a second accommodation space for accommodating the rear end side battery to connect the batteries is movable, whereby it is possible to minimize an opening portion for installing the batteries. For example, in an example of the battery accommodation structure described above, even if two batteries are accommodated so as to be arranged in series in the longitudinal direction, only the provision of an opening portion of a size slightly larger than a single battery makes it possible to accommodate both batteries.

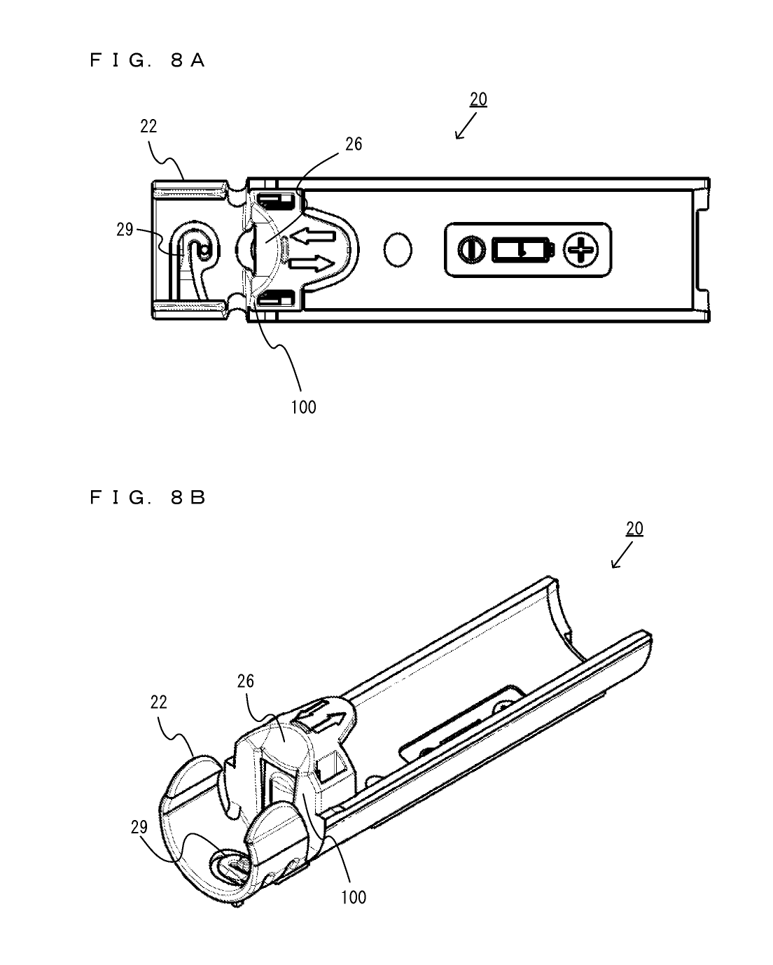

It should be noted that on the surface of the clamping spring 22 that clamps the rear end side battery, a mechanism (for example, a supporting spring) having a spring action for supporting the rear end side battery from below may be further provided. For example, as shown in FIGS. 8A and 8B, on the surface of the clamping spring 22 that clamps the rear end side battery, a notched spring 29 (a supporting spring) may be provided. It should be noted that FIG. 8A is an external top view of an example of the slider 20 in which the notched spring 29 is provided. FIG. 8B is an external perspective view of an example of the slider 20 in which the notched spring 29 is provided.

In FIGS. 8A and 8B, the notched spring 29 is formed by notching a part of the surface of the clamping spring 22 that clamps the rear end side battery, into a generally J-shape. Then, the notched spring 29 is so formed that the J-shaped portion protrudes further inward than the inner surface of the clamping spring 22 in contact with the rear end side battery. Consequently, the notched spring 29 has the function of giving a biasing force for pushing upward the rear end side battery clamped by the clamping spring 22. Thus, the force of the clamping spring 22 clamping the rear end side battery further increases by the biasing force of the notched spring 29. This makes it possible to accommodate the rear end side battery more stably. Further, also if rattling occurs between the outer peripheral surface of the rear end side battery and the inner surface of the clamping spring 22 due to variations in outer diameter of the rear end side battery or the like, the provision of the notched spring 29 can prevent the rattling.

Further, the configuration may be such that the supporting spring enables the clamping spring 22 to support batteries having different sizes. As an example, the inner surface of the clamping spring 22 may be formed into a shape that matches the outer peripheral surface of a size AA battery. Then, the protruding height of the supporting spring that protrudes further inward than the inner surface of the clamping spring 22 may be set such that the space surrounded by the supporting spring and the clamping spring 22 is formed into a shape that matches the outer peripheral surface of an AAA battery. This enables the clamping spring 22 to support a size AA battery, and enables the same clamping spring 22 to also support an AAA battery. It should be noted that a size AA battery and an AAA battery are different from each other not only in outer diameter but also in length in the longitudinal direction. The difference in length, however, may be adjusted by the expansion and contraction of the spring member included in the terminal connected to the batteries.

Further, as shown in FIGS. 8A and 8B, a guide slope 26 may be formed on the upper surface of the division wall 100 of the slider 20. For example, the guide slope 26 is formed as a planar surface or a curved surface inclined from the front end side to the rear end side of the slider 20. If the guide slope 26 is formed on the upper surface of the division wall 100, it is possible to insert the rear end side battery into the accommodation case 10 while sliding the positive electrode side of the rear end side battery on the inclined surface of the guide slope 26. For example, when the rear end side battery is inserted, even if the slider 20 is placed on the rear end side by the force of gravity or the biasing force of the terminal spring included in the front end side negative electrode terminal 23, the rear end side battery may be inserted while being guided by the guide slope 26. Thus, the rear end side battery is installed while the slider 20 moves in a sliding manner to the front end side. This eliminates the need for the work of moving the slider 20 to the front end side in advance to expand a space for the insertion of the rear end side battery in a pushing manner.

Further, the above exemplary embodiment has been described using an example where a movable partition portion (the division wall 100) for partitioning the accommodation case 10 into the first accommodation space for accommodating the front end side battery and the second accommodation space for accommodating the rear end side battery is slid in the longitudinal direction (the front-back direction) of the batteries, thereby changing the size of the first accommodation space. Alternatively, the partition portion may be moved in another direction, thereby achieving a similar function.

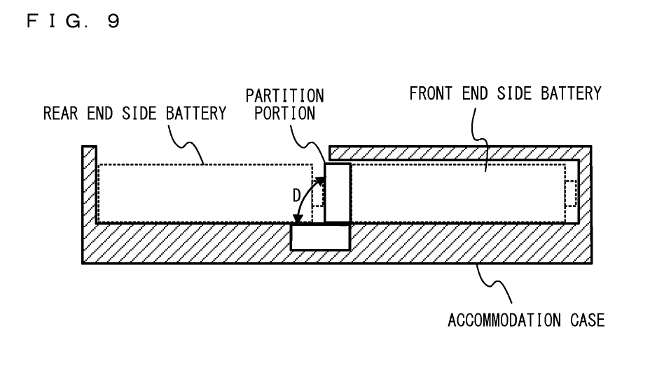

As a first example, as shown in FIG. 9, also a partition portion that can be displaced to be buried in a wall surface of a accommodation case and to stand in a battery accommodation space from the wall surface can achieve a similar function. As an example, the partition portion is displaced to be buried and to stand by pivoting in a direction D shown in FIG. 9. Then, the front end side battery may be inserted into the innermost portion of the accommodation case (to the right in FIG. 9) with the partition portion buried, and after the partition portion has pivot to stand, the rear end side battery may be inserted and assembled into the near side of the accommodation case (to the left in FIG. 9). This makes it possible to achieve a battery accommodation structure where an opening portion is made as small as possible in a similar manner.

As a second example, the structure may be such that a movable partition portion for partitioning a first accommodation space and a second accommodation space is moved in the front-back direction by rotating the partition portion about the axial direction of the batteries to be accommodated. As an example, a member for holding the front end side battery may be engaged with the main body, whereby it is possible to move the front end side battery by screwing the front end side battery together with the member for holding it to the front end side. This makes it possible to achieve a battery accommodation structure according to the second example.

As a third example, the structure may be such that a plurality of batteries are accommodated so as to be arranged side by side. In this case, a first accommodation space and a second accommodation space are provided so as to be arranged on either side, and a movable partition portion for partitioning the first accommodation space and the second accommodation space slides in the short direction (the left-right direction) of the batteries. This makes it possible to achieve a battery accommodation structure where after one battery (for example, a right battery) has been accommodated, the one battery is moved to the first accommodation space (for example, moved to the right) together with the partition portion, and the other battery (for example, a left battery) is accommodated in the second accommodation space emptied by the movement of the one battery.

Further, in the above exemplary embodiment, the configuration is such that the slider 20 is slid, thereby allowing a plurality of batteries to be accommodated in the accommodation case 10. To obtain only the effect of supporting batteries with the clamping spring 22, however, a battery accommodation structure for accommodating a single battery may be used. In this case, the battery accommodation structure includes an accommodation case in which a terminal and a terminal spring to be connected to an electrode of a battery to be accommodated are provided at its front and rear ends and which can accommodate a single battery, and a clamping spring provided in the accommodation case. It should be noted that in the battery accommodation structure, a terminal spring provided in the accommodation case typically has the function of connecting to the negative electrode of a battery to be accommodated. Alternatively, the battery accommodation structure may include a torsion spring (a twisted spring), or may include a coiled terminal spring or the like.

Further, it goes without saying that the shapes of components, the materials of components, the number of components, the placement positions of components, the functions of components, and the like used in the battery accommodation mechanism described above are merely illustrative, and may be other shapes, materials, numbers, and placement positions, and other functions may also be able to achieve the exemplary embodiment. For example, a description has been given using an example where the rear end side negative electrode terminal 12 includes a torsion spring. Alternatively, the rear end side negative electrode terminal 12 may include a single torsion spring, or may include a plurality of torsion springs, or may include another spring that biases the rear end side battery by the biasing force in the front end side direction by contracting to the rear end side in accordance with the insertion of the rear end side battery from above. Yet alternatively, the rear end side negative electrode terminal 12 may include a spring material that allows the insertion of a battery only from the front end side, such as a coiled terminal spring, or may include another spring material having spring characteristics. Further, a description has been given using an example where the front end side negative electrode terminal 23 includes a coiled terminal spring. Alternatively, the front end side negative electrode terminal 23 may include a spring such as a torsion spring that biases the front end side battery by the biasing force in the front end side direction by contracting to the rear end side in accordance with the insertion of the front end side battery from above, or may include another spring material that allows the insertion of a battery only from the front end side, or may include another spring material having spring characteristics. Yet alternatively, the front end side positive electrode terminal and/or the rear end side positive electrode terminal may include a spring material having spring characteristics. The above exemplary embodiment has been described using an example where two batteries (the front end side battery and the rear end side battery) are installed. Alternatively, three or more batteries may be able to be installed into the battery accommodation mechanism.

While some exemplary systems, exemplary methods, exemplary devices, and exemplary apparatuses have been described in detail above, the above descriptions are merely illustrative in all respects, and do not limit the scope of the systems, the methods, the devices, and the apparatuses. It goes without saying that the systems, the methods, the devices, and the apparatuses can be improved and modified in various manners without departing the spirit and scope of the appended claims. It is understood that the scope of the systems, the methods, the devices, and the apparatuses should be interpreted only by the scope of the appended claims. Further, it is understood that the specific descriptions of the exemplary embodiment enable a person skilled in the art to carry out an equivalent scope on the basis of the descriptions of the exemplary embodiment and general technical knowledge. It should be understood that, when used in the specification, the components and the like described in the singular with the word “a” or “an” preceding them do not exclude the plurals of the components. Furthermore, it should be understood that, unless otherwise stated, the terms used in the specification are used in their common meanings in the field. Thus, unless otherwise defined, all the jargons and the technical terms used in the specification have the same meanings as those generally understood by a person skilled in the art in the field of the exemplary embodiment. If there is a conflict, the specification (including definitions) takes precedence.

As described above, the exemplary embodiment is useful as, for example, a battery accommodation structure, a battery accommodation method, and the like in order, for example, to accommodate a battery without supporting the battery using a cover to be attached after the accommodation of the battery, using a holding member or the like.

What is claimed is:

1. A battery accommodation structure for accommodating a battery, the battery accommodation structure comprising, in an accommodation case configured to accommodate the battery:
a positive electrode terminal connected to a positive electrode of the battery;
a negative electrode terminal connected to a negative electrode of the battery; and
a clamping spring provided between the positive electrode terminal and the negative electrode terminal and configured to clamp a part of an outer peripheral surface of the battery.

2. The battery accommodation structure according to claim 1, wherein
the negative electrode terminal includes a terminal spring, and
the clamping spring is provided in an accommodation space in the accommodation case on the positive electrode terminal side, the accommodation space formed between the positive electrode terminal and the negative electrode terminal.

3. The battery accommodation structure according to claim 2, wherein
the clamping spring is provided at a position where the clamping spring clamps an outer peripheral surface of a part closest to the positive electrode among parts obtained by dividing the battery accommodated in the accommodation case into quarters in a longitudinal direction.

4. The battery accommodation structure according to claim 1, wherein
the negative electrode terminal includes a torsion spring.

5. The battery accommodation structure according to claim 1, wherein
the clamping spring includes a supporting spring configured to, in an inner surface thereof clamping the battery by abutting an outer peripheral surface of the battery on both sides, protrude further inward than the inner surface from a lower portion of the inner surface to support the outer peripheral surface of the battery in an upward direction from the lower portion.

6. The battery accommodation structure according to claim 1, further comprising
a cover configured to detachably cover the accommodated battery, wherein
if the cover has been attached, an inner surface of the cover abuts at least a part of an outer surface of the clamping spring.

7. A battery accommodation method for accommodating a battery, the battery accommodation method comprising
electrically connecting electrodes of a battery to be accommodated to a positive electrode terminal and a negative electrode terminal by fitting the electrodes between the positive electrode terminal and the negative electrode terminal, and accommodating the battery in the accommodation case by clamping a part of the outer peripheral surface of the battery with a clamping spring.
